(19) United States
(12) Patent Application Publication
(10) Pub. No.: US 2005/0126697 A1
(43) Pub. Date: Jun. 16, 2005

(54) Photochemically and thermally curable adhesive formulations

(75) Inventor: Joseph Kuczynski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/733,695

(22) Filed: Dec. 11, 2003

(51) Int. Cl. C08G 2/00; C08F 2/46; B32B 31/00

(52) U.S. Cl. 156/275.7; 522/1

(57) ABSTRACT

A method for curing a formulation comprising a curable composition by treating the formulation with radiation having a wavelength between about 220 nm and about 600 nm and heating the formulation to generate either acid or base curing agents is provided. A formulation comprising the curable composition, a thermal initiator, and a photoinitiator to generate the acid or base curing agents is also provided. The curable composition may be an epoxy-based composition.

### BACKGROUND OF THE INVENTION

1. Field of the Invention

The present invention generally relates to curable formulations and methods of curing formulations.

2. Description of the Related Art

Epoxy-based resins are often used as layers or adhesives in the formation of electronic devices. To form the adhesives, the epoxy-based resins are typically either photochemically or thermally cured.

Epoxy-based resins are generally photochemically cured by adding an onium salt photoinitiator to the epoxy-based resin and exposing the resulting formulation to UV radiation. The UV radiation photolyzes the photoiniator to generate an acid, such as hexafluoroantimonic acid (HSbF₆), hexafluorophosphoric acid (HPF₆), tetrafluoroboric acid (HBF₄), or triflic acid (CF₃SO₃H), that yields a proton that attacks the oxirane oxygen of the epoxy group and results in cationic curing of the epoxy-based resin. Onium salt photoinitiators that generate hexafluoroantimonic acid are preferred, as hexafluoroantimonic acid typically cures epoxy-based resins fasters than other acids that have been tested.

Epoxy-based resins are generally thermally cured by adding a thermal initiator, such as an anhydride, mercaptan, aliphatic amine, aromatic amine, or nitrogen-containing heterocycle, and heating the resulting formulation. Typically, the thermal initiator includes a basic group that attacks the alpha carbon of the epoxy group. A near stoichiometric ratio of epoxy to thermal initiator is required for curing of the formulation. Thus, the curable formulation contains a substantial amount of the thermal initiator.

While photochemically curing or thermally curing an epoxy-based resin is often sufficient to completely cure an epoxy-based resin, there are situations in which a photochemical cure or a thermal cure is not sufficient or practical to completely cure the epoxy-based resin. For example, if an epoxy-based resin is applied on a structure wherein part of the structure shields part of the epoxy-based resin from exposure to the photochemical curing source, such as UV radiation, the shielded part of the epoxy-based resin may remain uncured while the rest of the resin is cured. While the epoxy-based resin on such a structure can be cured completely by a thermal cure, a thermal cure typically requires several hours for the epoxy-based resin to set and function as an adhesive to bond parts of the structure together.

Attempts have been made to photochemically cure formulations that include an epoxy-based resin and one of the thermal initiators and one of the photoinitiators described above. However, these attempts have been unsuccessful. The large amount of basic thermal curing agent in the formulations scavenges protons generated by the acid of the photoinitiator, and thus inhibits the cationic curing activity of the photoinitiator.

Therefore, there remains a need for a formulation that is both thermally and photochemically curable and for a method of curing a formulation by both a thermal curing process and a photochemical curing process.

### SUMMARY OF THE INVENTION

The present invention generally provides a method of curing a curable formulation, comprising adding a thermal initiator and a photoinitiator to a curable composition to make the formulation and then treating the formulation with radiation having a wavelength between about 220 nm and about 600 nm, e.g., UV radiation, and heating the formulation to generate either acid curing agents or base curing agents. The formulation is treated with sufficient radiation having a wavelength between about 220 nm and about 600 nm to generate a first active curing agent from the photoinitiator. The formulation is heated at a temperature sufficient to generate a second active curing agent from the thermal initiator. The active curing agents generated from the photoinitiator and from the thermal initiator are either both acids or both bases. In one aspect, treating the formulation with sufficient radiation to generate an active curing agent from the photoinitiator cures a first part of the formulation and heating the formulation to generate an active curing agent from the thermal initiator cures a second part of the formulation. For example, heating the formulation to generate an active curing agent from the thermal initiator may cure a part of the formulation that is not cured upon exposure of the formulation to radiation having a wavelength between about 220 nm and about 600 nm because that part of the formulation is shielded from the radiation.

In another aspect, a formulation comprising a curable composition, a photoinitiator, and a thermal initiator is provided, wherein the formulation is curable with radiation having a wavelength between about 220 nm and about 600 nm and with heat to generate either acid or base curing agents from the photoinitiator and the thermal initiator. In one aspect, the photoinitiator and the thermal initiator generate the same curing agent.

In another aspect, a method of forming a connection between an electronic device and an underlying substrate is provided, the method comprising placing a formulation comprising a curable composition, a photoinitiator, and a thermal initiator between the electronic device and the underlying substrate, and then treating the formulation with radiation having a wavelength between about 220 nm and about 600 nm and heating to generate either acid or base active curing agents from the photoinitiator and the thermal initiator.

A structure comprising an electronic device, an underlying substrate, and a formulation between the device and the substrate is also provided, wherein the structure is produced by a process comprising placing the formulation between the electronic device and the underlying substrate, the formulation comprising a curable composition, a photoinitiator, and a thermal initiator, and then treating the formulation with radiation having a wavelength between about 220 nm and about 600 nm and heating the formulation to generate either acid or base curing agents from the photoinitiator and the thermal initiator.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a flow diagram showing an embodiment of the invention.

FIG. 2 (prior art) is a DSC thermogram of the embodiment described in Comparison Example 1.

FIG. 3 is a DSC thermogram of the embodiments described in Example 2 and in Comparison Examples 2 and 3.

FIG. 4 is a structure comprising a BGA chip connected to a substrate and an epoxy-based resin that is cured according to an embodiment of the invention.

### DETAILED DESCRIPTION OF THE PREFERRED EMBODIMENTS

The present invention provides methods for curing a formulation that comprises a thermal initiator and a photoinitiator. The thermal initiator and the photoinitiator are added to a curable composition, such as an epoxy-based composition. Epoxy-based compositions that may be used include cycloaliphatic epoxy resins, bisphenol A epoxy resins, epoxy acrylates, and epoxy novolacs. An example of a cycloaliphatic epoxy resin that may be used is 3,4-epoxycyclohexylmethyl-3,4-epoxycylohexanecarboxylate, such as Union Carbide ERL 4221 resin. An example of a bisphenol A epoxy resin that may be used is Shell Epon 828 resin. The epoxy-based compositions may be used as epoxy-based adhesives.

In one embodiment, the thermal initiator and the photoinitiator each generate an active curing agent that catalyzes the curing of the formulation. The active curing agent generated from the thermal initiator and the active curing agent generated from the photoinitiator are either both acids or both bases. As defined herein, “acids” include both Lewis acids and Lowry-Bronsted acids, and “bases” include both Lewis bases and Lowry-Bronsted bases. As the active curing agents generated from the combinations of the thermal initiators and the photoinitiators described herein are either both acids or both bases, the thermal initiators and the photoinitiators can be used together without generating an active curing agent from one of the initiators that inactivates the curing agent generated by the other initiator. Thus, formulations including the combinations of thermal initiators and photoinitiators described herein can be cured by both thermal curing processes and photochemical curing processes.

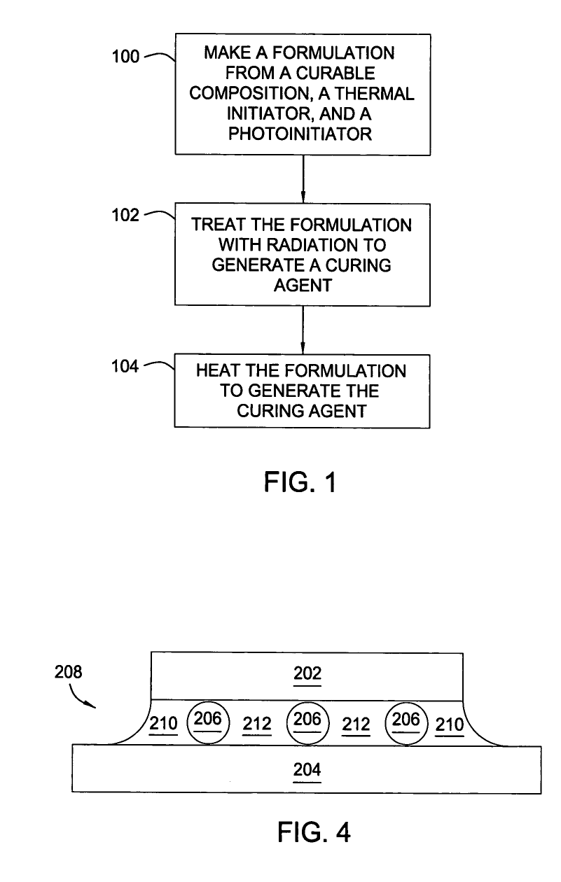

In one embodiment, shown in FIG. 1, the active curing agent generated from the thermal initiator is the same as the active curing agent generated from the photoinitiator. In step 100, a formulation is made from a curable composition, a thermal initiator, and a photoinitiator. In step 102, the formulation is treated with radiation having a wavelength between about 220 nm and about 600 nm to generate a curing agent from the photoinitiator. The formulation may be treated with radiation having a wavelength between about 220 nm and about 600 nm for a period of time, such as about 5 seconds to about 30 seconds. In step 104, the formulation is heated to generate a curing agent from the thermal initiator which is identical to the curing agent generated by the photoinitiator. The formulation may be heated in a batch oven for about 15 minutes to about 24 hours. The formulation is heated to a temperature that is selected based on the particular thermal initiator that is used, as described above. For example, a formulation containing Nacure XC-7231 initiator may be heated to a temperature greater than about 80° C.

While FIG. 1 illustrates an embodiment in which the formulation is treated with radiation having a wavelength between about 220 nm and about 600 nm and then heated, in other embodiments, the formulation may be heated and then treated with radiation having a wavelength between about 220 nm and about 600 nm or the formulation may be heated and treated with radiation having a wavelength between about 220 nm and about 600 nm simultaneously.

While embodiments of the invention provide a method of curing a formulation comprising a curable composition by exposing the formulation to radiation having a wavelength between about 220 nm and about 600 nm and heating the formulation, it is recognized that, generally, parts or regions of the formulation will be photochemically cured, while other parts or regions of the formulation will be thermally cured. For example, a part of the formulation that is shielded from the radiation and thus is not cured upon exposure to radiation may be cured upon heating the formulation. Alternatively, parts of regions of the formulation may be cured photochemically and then further cured by heating, and vice versa.

In one embodiment, the active curing agent generated from the photoinitiator and the active curing agent generated from the thermal initiator are both acids. Examples of photoinitiators that are photoacid generators, i.e., generate an acid as an active curing agent, include onium salts, photodecomposable organosilanes, and iron arene compounds. Examples of onium salts include sulphonium salts, such as triarylsulphonium salts, diazonium salts, and halonium salts, such as diaryliodonium salts, polymer-bound iodonium salts, and diarylhalonium salts. Examples of photodecomposable organosilanes include O-nitrobenzyl triarylsilyl ethers, triarylsilyl peroxides, and acylsilanes. Other photoinitiators that generate an acid as an active curing agent include halomethyl striazines and chlorinated acetophenones.

When the photoinitiator generates an acid curing agent, the thermal initiator may be Nacure XC-7231 initiator, which is a catalyst based on a quaternary hexafluoroantimonate salt, available from King Industries of Norwalk, Conn. The active curing agent generated by Nacure XC-7231 initiator is hexafluoroantimonic acid (HSbF₆).

The concentration of the photoacid generator in the formulation may be from about 0.1 wt % to about 10.0 wt %, preferably from about 1.0 wt % to about 6.0 wt %, and most preferably from about 2.0 wt % to about 3.0 wt %. The concentration of the thermal initiator that is an acid generator may be from about 0.1 wt % to about 10.0 wt %, preferably from about 1.0 wt % to about 6.0 wt %, and most preferably from about 2.0 wt % to about 3.0 wt %.

In embodiments in which the active curing agents generated from the photoinitiator and from the thermal initiator are both acids, an active curing agent is generated from the photoinitiator by treating a formulation including a thermal initiator, a photoinitiator, and a curable composition with radiation having a wavelength between about 220 nm and about 600 nm, preferably between about 300 nm and about 450 nm, and most preferably between about 310 nm and about 425 nm. A suitable radiation source is a medium pressure mercury arc lamp. The formulation may be exposed to radiation for a period of time, such as about 5 seconds to about 30 seconds, to achieve an exposure dose of between about 5 mJ/cm² and about 10 J/cm². The active curing agent is generated from the thermal initiator by heating the formulation at a sufficient temperature to generate the active curing agent, such as at a temperature between about 80° C. and about 250° C., preferably at a temperature between about 90° C. and about 150° C., and most preferably at a temperature between about 100° C. and about 125° C. The formulation may be heated for a period of time, such as about 15 minutes, such as at temperatures greater than 200° C., to about 4 hrs, such as at temperatures of about 80° C. The times and temperatures sufficient for curing can be readily determined by one skilled in the art.

In another embodiment, the active curing agent generated from the photoinitiator and the active curing agent generated from the thermal initiator are both bases. Examples of photoinitiators that are photobase generators, i.e., that generate a base as an active curing agent include amines, N-([(4,5-methoxy-2-nitrobenzyl)oxy]-carbonyl-2,6-dimethylpiperidine, benzoin carbamates, O-acyloximes, and metal-bound photobase generators. Examples of amines that may be used include ortho-nitrobenzyloxycarbonyl amines, photolatent amines, and photolatent tertiary amines. Photolatent amines include anilide derivatives. Photolatent tertiary amines include ammonium salts of a-ketocarboyxlic acid and other carboxylates, benzhydrylammonium salts, and N(Benzophenonylmethyl)-tri-N-alkylammonium triphenylalkylborates. Metal-bound photobase generators include cobalt amine complexes, tungsten and chromium pyridine pentacarbonyl complexes, chromium and cobalt complexes, platinum acetylacetonate, and iron (II) and ruthenium (II) cyclopentadienyl complexes.

When the photoinitiator generates a base curing agent, the thermal initiator may be an anhydride, mercaptan, amine, or a nitrogen-containing heterocycle. An example of a thermal initiator that may be used is the aliphatic amine DOW DEH 29.

The sum of the concentration of the photoinitiator and the thermal initiator may be from about 20% less than the epoxy resin epoxy equivalent weight (EEW) to about 20% more than the EEW, preferably from about 10% less than the EEW to about 10% more than the EEW, most preferably from about 1% less than the EEW to about 1% more than the EEW. Preferably, a near stoichoimetric ratio of the sum of the concentrations of the photoinitiator and the thermal initiator to the curable composition is used.

In embodiments in which the active curing agents generated from the photoinitiator and from the thermal initiator are both bases, an active curing agent is generated from the photoinitiator by treating a formulation including a thermal initiator, a photoinitiator, and a curable composition with radiation having a wavelength between about 220 nm and about 600 nm, preferably between about 225 nm and about 450 nm, and most preferably between about 250 nm and about 425 nm. A suitable radiation source is a medium pressure mercury arc lamp. The formulation may be exposed to radiation for a period of time, such as about 5 seconds to about 30 seconds, to achieve an exposure dose of between about 5 mJ/cm² and about 10 J/cm². The active curing agent is generated from the thermal initiator by heating the formulation at a sufficient temperature to generate the active curing agent, such as at a temperature between about 25° C. and about 250° C., preferably at a temperature between about 50° C. and about 150° C., and most preferably at a temperature between about 100° C. and about 125° C. The formulation may be heated for a period of time, such as about 30 minutes, such as at temperatures greater than 200° C., to about 24 hrs, such as at temperatures of about 25° C. The times and temperatures sufficient for curing can be readily determined by one skilled in the art.

Embodiments of the invention are further illustrated by the Examples provided below.

### COMPARISON EXAMPLE 1

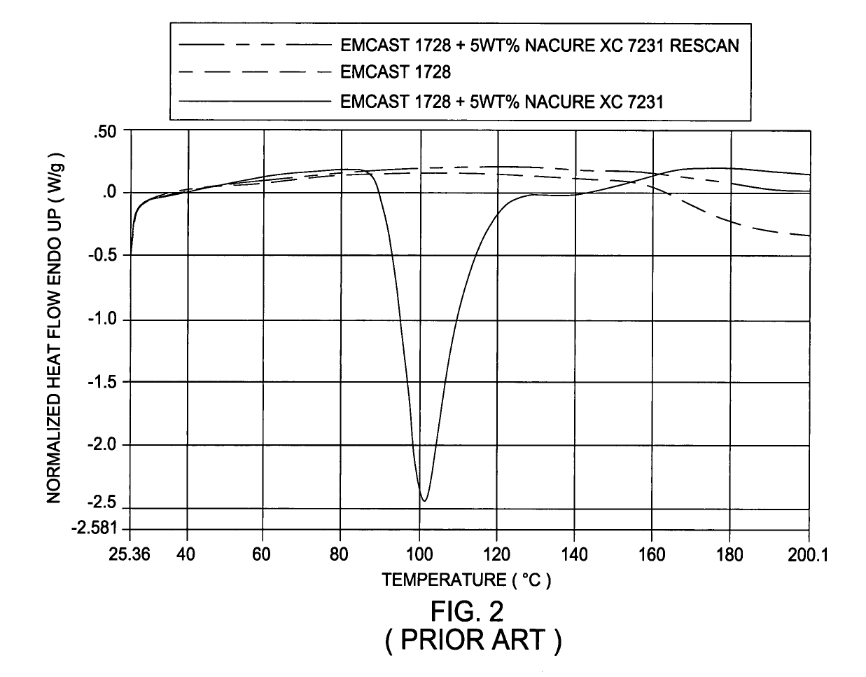

EMCAST 1728, a UV-curable adhesive composition that is available from Electronic Materials, Inc. and includes the epoxy-based resin ERL 4221 and a triarylsulphonium hexafluoroantimonate salt as the photoinitiator, was heated to a temperature of about 200° C. without curing the composition, as shown in the DSC (differential scanning calorimetry) thermogram in FIG. 2. A second formulation comprising EMCAST 1728 resin and 5.0 wt % of Nacure XC-7231 initiator was also heated. The second formulation cured, as shown by the rescan in FIG. 2.

Comparison Example 1 illustrates that the UV-curable EMCAST 1728 can be thermally cured by adding Nacure XC-7231 initiator to the composition and heating the resulting formulation.

### COMPARISON EXAMPLE 2

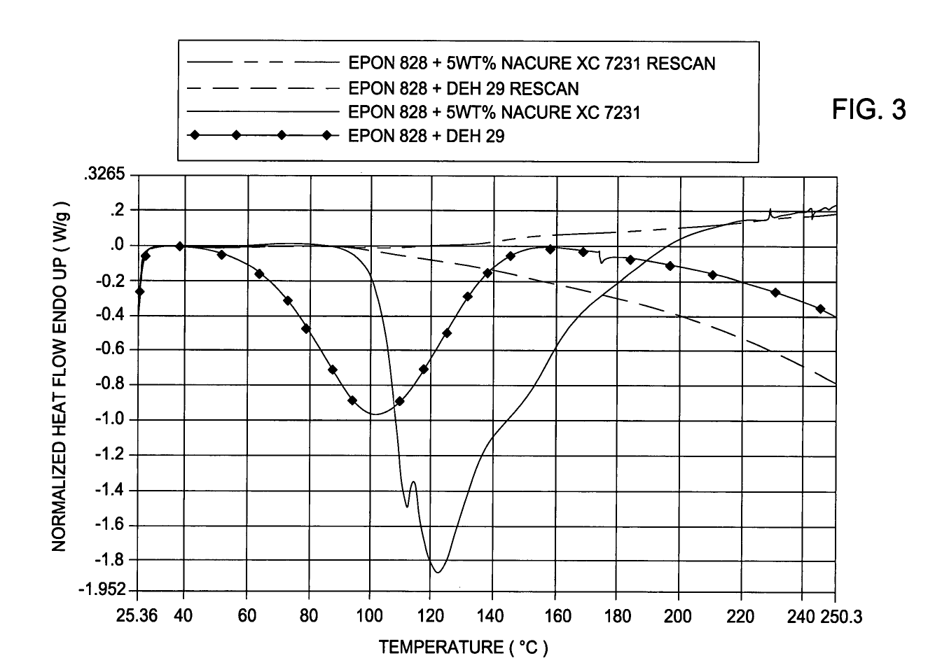

A formulation comprising a bisphenol A epoxy resin, Shell Epon 828 resin, and an aliphatic amine thermal initiator, DOW DEH 29 initiator, was heated to a temperature of about 250° C., as shown in the DSC thermogram in FIG. 3. The formulation cured, as shown by the re-scan. The formulation had a glass transition temperature of about 75° C.

### COMPARISON EXAMPLE 3

A formulation comprising the Shell Epon 828 resin and the Nacure XC-7231 initiator was heated to a temperature of about 250° C., as shown in FIG. 3. The formulation cured, as shown by the re-scan. The formulation had a glass transition temperature of about 140° C.

Comparison Example 2 illustrates that the bisphenol A epoxy resin, Shell Epon 828 resin, can be thermally cured by adding the thermal initiator DOW DEH 29 to the resin and heating the resulting formulation. Comparison Example 3 illustrates that the Shell Epon 828 resin can be thermally cured by adding the thermal initiator Nacure XC-7231 to the resin and heating the resulting formulation. The formulation of Comparison Example 3 yielded a more desirable curing process than the formulation of Comparison Example 2, as the formulation of Comparison Example 3 had a higher glass transition temperature and a larger exotherm with a better defined onset than the formulation of Comparison Example 2.

### COMPARISON EXAMPLE 4

A formulation comprising 3,4-epoxycyclohexylmethyl-3,4-epoxycyclo-hexanecarboxylate or the bisphenol A epoxy resin, Shell Epon 828 resin, and 2-3 wt % triarylsulphonium hexafluoroantimonate photoinitiator was heated at 150° C. for 60 minutes. After heating, the formulation remained soft without an observable increase in viscosity. DSC revealed that the formulation was thermally stable to temperatures in excess of 200° C. FTIR analysis of the formulation indicated that curing did not occur. Exposure of the formulation to radiation having a wavelength between about 220 nm and about 600 nm at 1 J/cm² from a mercury arc lamp resulted in complete conversion of the epoxy groups and curing of the formulation.

### COMPARISON EXAMPLE 5

A formulation comprising 3,4-epoxycyclohexylmethyl-3,4-epoxycyclo-hexanecarboxylate or Shell Epon 828 resin and 5 wt % of Nacure XC-7231 initiator was exposed to radiation having a wavelength between about 220 nm and about 600 nm at 1 J/cm² from a mercury arc lamp. There was no observable change in the viscosity of the formulation, and FTIR analysis indicated that the formulation did not cure. The formulation was heated at 100° C. for 60 minutes. The formulation vitrified. The glass transition temperature of the cured formulation was 140° C. Complete conversion of the epoxy groups was confirmed via DSC and FTIR analysis.

### COMPARISON EXAMPLE 6

A formulation comprising the bisphenol A epoxy resin, Shell Epon 828 resin, and a stoichiometric concentration of the aliphatic amine thermal initiator, DOW DEH 29 initiator (100 epoxy resin: 15.3 amine), was cured at 100° C. for 60 minutes. The glass transition temperature of the cured formulation was 75° C.

Comparison Example 4 illustrates that the photoinitiator triarylsulphonium hexafluoroantimonate catalyzes the curing of an epoxy resin when it is exposed to radiation having a wavelength between about 220 nm and about 600 nm, but does not catalyze curing of an epoxy resin when it is exposed to heat. Comparison Example 5 illustrates that the thermal initiator Nacure XC-7231 catalyzes the curing of an epoxy resin when it is exposed to heat, but not when it is exposed to radiation having a wavelength between about 220 nm and about 600 nm. Comparison Example 5 also shows that thermally curing an epoxy resin with Nacure XC-7231 provides a cured formulation that has a desirable higher glass transition temperature than a cured formulation provided by thermally curing an epoxy resin with an aliphatic amine thermal initiator, as described in Comparison Example 6.

### EXAMPLE 1

A formulation comprising 3,4-epoxycyclohexylmethyl-3,4-epoxycyclo-hexanecarboxylate or Shell Epon 828 resin, 2-3 wt % triarylsulphonium hexafluoroantimonate photoinitiator, and 5 wt % of Nacure XC-7231 initiator was heated at 150° C. for 60 minutes. Complete conversion of the epoxy groups was confirmed via DSC and FTIR. Alternatively, exposure of the formulation to radiation having a wavelength between about 220 nm and about 600 nm at 1 J/cm² from a mercury arc lamp also resulted in complete conversion of the epoxy groups.

Example 1 illustrates that a formulation comprising an epoxy resin, triarylsulfonium hexafluoroantimonate, and Nacure XC-7231 can be cured by exposing the formulation to radiation having a wavelength between about 220 nm and about 600 nm, by heating the formulation, or both.

### COMPARISON EXAMPLE 7

The formulation of Comparison Example 4 was dispensed under a ball grid array (BGA) chip to serve as an underfill encapsulant to provide stress relief to the solder balls. A structure 200 including a BGA chip is shown in FIG. 4. BGA chip 202 is connected to substrate 204, which may be a printed circuit board (PCB), via solder balls 206. The formulation 208 is provided as an underfill. A fillet 210 of the formulation is formed as result of the surface tension between the underfill and the substrate. Exposure of the underfill to radiation having a wavelength between about 220 nm and about 600 nm at 1 J/cm² from a mercury arc lamp cured the fillet 210 but did not cure the bulk 212 of the underfill. The structure was then baked at 100° C. for 60 minutes, but the bulk 212 of the underfill remained uncured.

### EXAMPLE 2

The formulation of Example 1 was dispensed under a BGA chip 202, exposed to UV radiation, and heated according to the process described in Comparison Example 7. As in Comparison Example 7, exposing the underfill to radiation having a wavelength between about 220 nm and about 600 nm cured the fillet 210 but did not cure the bulk 212 of the underfill. The structure was then baked at 100° C. for 60 minutes. The bulk 212 of the underfill was cured.

Comparison Example 7 provides an example of a situation in which a formulation that is curable by UV radiation cannot be adequately cured by radiation having a wavelength between about 220 nm and about 600 nm, as parts of the formulation are hidden or shielded from the radiation having a wavelength between about 220 nm and about 600 nm by the structure surrounding the formulation. Example 2 shows that a hidden region of a formulation that cannot be cured by radiation having a wavelength between about 220 nm and about 600 nm can be cured if the formulation includes an active thermal initiator in addition to a photoinitiator.

### HYPOTHETICAL EXAMPLE 1

A formulation comprising Shell Epon 828 resin, DOW DEH 29 initiator, and N-([(4,5-methoxy-2-nitrobenzyl)oxy]-carbonyl-2,6-dimethylpiperidine curable by heating at 250° C. for 15 minutes. Alternatively, exposure of the formulation to radiation having a wavelength between about 220 nm and about 600 nm at 4.5 J/cm² from a mercury arc lamp would also cure the formulation.

### HYPOTHETICAL EXAMPLE 2

The formulation of Hypothetical Example 1 is dispensed under a BGA chip 202, exposed to UV radiation, and heated according to the process described in Hypothetical Example 1. Exposing the underfill to radiation having a wavelength between about 220 nm and about 600 nm will cure the fillet 210 but not cure the bulk 212 of the underfill. Heating the structure at 250° C. for 15 minutes will cure the bulk 212 of the underfill.

Thus, embodiments of formulations that can be photochemically and thermally cured, and methods of curing the same, are provided. The formulations and methods described herein may be used, for example, to photochemically cure the edges of the formulation to fix a device to a substrate and to prevent the formulation from flowing away from the device and the substrate. Then, at a later time, the curing of the formulation can be completed by thermally curing the formulation. However, persons skilled in the art will recognize a variety of other applications and embodiments, all within the scope of the invention.

While the foregoing is directed to embodiments of the present invention, other and further embodiments of the invention may be devised without departing from the basic scope thereof, and the scope thereof is determined by the claims that follow.

1. A method of curing a formulation, comprising:
adding a thermal initiator and a photoinitiator to a curable composition to make a formulation;
treating the formulation with sufficient radiation having a wavelength between about 220 nm and about 600 nm to generate a first active curing agent from the photoinitiator; and
heating the formulation at a temperature sufficient to generate a second active curing agent from the thermal initiator, wherein the first active curing agent and the second active curing agent are both acids or both bases.

2. The method of claim 1, wherein the treating the formulation with sufficient radiation cures a first part of the formulation and the heating the formulation cures a second part of the formulation.

3. The method of claim 1, wherein the heating the formulation cures a part of the formulation that is shielded from the radiation.

4. The method of claim 1, wherein the second active curing agent is identical to the first active curing agent.

5. The method of claim 4, wherein the first active curing agent is hexafluoroantimonic acid.

6. The method of claim 1, wherein the thermal initiator is Nacure XC-7231 initiator.

7. The method of claim 1, wherein the photoinitiator is selected from the group consisting of onium salts, photodecomposable organosilanes, and iron arene compounds.

8. The method of claim 7, wherein the photoinitiator is an onium salt selected from the group consisting of sulphonium salts, diazonium salts, and halonium salts.

9. The method of claim 7, wherein the photoinitiator is a photodecomposable organosilane selected from the group consisting of O-nitrobenzyl triarylsilyl ethers, triarylsilyl peroxides, and acylsilanes.

10. The method of claim 1, wherein the thermal initiator is selected from the group consisting of anhydrides, mercaptans, amines, and nitrogen-containing heterocycles.

11. The method of claim 1, wherein the photoinitiator is selected from the group consisting of amines, N-([(4,5-methoxy-2-nitrobenzyl)oxy]-carbonyl-2,6-dimethylpiperidine, benzoin carbamates, O-acyloximes, and metal-bound photobase generators.

12. The method of claim 11, wherein the photoinitiator is an amine selected from the group consisting of ortho-nitrobenzyloxycarbonyl amines, photolatent amines, and photolatent tertiary amines.

13. The method of claim 1, wherein the curable composition is an epoxy-based composition.

14. The method of claim 13, wherein the epoxy-based composition is selected from the group consisting of cycloaliphatic epoxy resins, bisphenol A epoxy resins, epoxy acrylates, and epoxy novolacs.

15. The method of claim 1, wherein the formulation is treated with the radiation before the heating the formulation.

16. The method of claim 1, wherein the formulation is treated with the radiation during the heating the formulation.

17. A formulation comprising:
a curable composition;
a photoinitiator; and
a thermal initiator, wherein the formulation is curable with radiation having a wavelength between about 220 nm and about 600 nm and with heat to generate a first active curing agent from the thermal initiator and a second active curing agent from the photoinitiator, and wherein the first active curing agent and the second active curing agent are both acids or both bases.

18. The formulation of claim 17, wherein the second active curing agent is identical to the first active curing agent.

19. The formulation of claim 18, wherein the first active curing agent is hexafluoroantimonic acid.

20. A method of forming a connection between an electronic device and an underlying substrate, comprising:
placing a formulation between the electronic device and the underlying substrate, the formulation comprising a cationically curable composition, a photoinitiator, and a thermal initiator;
treating the formulation with sufficient radiation having a wavelength between about 220 nm and about 600 nm to generate a first active curing agent; and
heating the formulation at a temperature sufficient to generate a second active curing agent from the thermal initiator, wherein the first active curing agent and the second active curing agent are both acids or both bases.

21. The method of claim 20, wherein the treating the formulation with sufficient radiation cures a first part of the formulation and the heating the formulation cures a second part of the formulation.

22. The method of claim 20, wherein the heating the formulation cures a part of the formulation that is shielded from the radiation.

23. The method of claim 20, wherein the second active curing agent is identical to the first active curing agent.

24. The method of claim 23, wherein the first active curing agent is hexafluoroantimonic acid.

25. The method of claim 20, wherein the curable composition is an epoxy-based composition.

26. The method of claim 20, wherein the thermal initiator is Nacure XC-7231 initiator.

27. The method of claim 20, wherein the formulation is treated with the radiation prior to the heating the formulation.

28. The method of claim 20, wherein the formulation is treated with the radiation during the heating the formulation.

29. A structure comprising an electronic device, an underlying substrate, and a cured formulation between the device and the substrate, produced by a process comprising:
placing a formulation between the electronic device and the underlying substrate, the formulation comprising a curable composition, a photoinitiator, and a thermal initiator;
treating the formulation with sufficient radiation having a wavelength between about 220 nm and about 600 nm to generate a first active curing agent from the photoinitiator; and
heating the formulation at a temperature sufficient to generate a second active curing agent from the thermal initiator, wherein the first active curing agent and the second active curing agent are both acids or both bases.

30. The structure of claim 29, wherein the second active curing agent is identical to the first active curing agent.

31. The structure of claim 30, wherein the first active curing agent is hexafluoroantimonic acid.
